(19) United States
(12) Patent Application Publication
(10) Pub. No.: US 2023/0217050 A1
(43) Pub. Date: Jul. 6, 2023

(54) METHODS AND SYSTEMS FOR RESOURCE MANAGEMENT

(71) Applicant: Comcast Cable Communications, LLC, Philadelphia, PA (US)

(72) Inventors: John BIEBERLY, Centennial, CO (US); Nicholas Mandato, Centennial, CO (US); Jonathan Kirkovich, Centennial, CO (US)

(21) Appl. No.: 17/566,122

(22) Filed: Dec. 30, 2021

(51) Int. Cl. H04N 21/2383; H04N 19/136; H04N 19/156; H04N 21/262

(52) U.S. Cl. CPC H04N 21/2383; H04N 19/136; H04N 19/156; H04N 21/262

(57) ABSTRACT

Methods and systems for resource management are described. A computing device may determine a duration of a content break satisfies a timing threshold. Based on the duration of the content break satisfying the timing threshold, the computing device may cause an encoder to cease an encoding operation. Based on the duration of the content break satisfying the timing threshold, the computing device may cause the encoder to send to a media device, secondary content and cause the media device to repeatedly output the secondary content rather than sending repeated requests for the secondary content.

### BACKGROUND

Content distributors frequently use slates (moving or still video frames indicating no programming content is available) to indicate to viewers that a particular video service is not active or is otherwise unavailable on a given channel. For example, at the end of an out-of-market sporting event or before a pay-per-view (PPV) event begins, the content distributor may cause a slate to be displayed on the channel associated with the sporting event or PPV event. These slates require the same or nearly the same bandwidth as an active video service (e.g., regular programming). Thus, improved methods and systems are required to better manage network resources.

### SUMMARY

It is to be understood that both the following general description and the following detailed description are exemplary and explanatory only and are not restrictive. Methods and systems for resource management are described. A content distribution device may determine a break in content that satisfies a threshold and cause one or more downstream devices to store and loop content for the duration of the break. This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, show examples and together with the description, serve to explain the principles of the methods and systems:

FIGS. 1A-1B show an example system for resource management;

FIG. 2 shows an example broadcast schedule;

FIG. 3 shows a flowchart of an example method for resource management;

FIG. 4 shows a flowchart of an example method for resource management;

FIG. 5 shows a flowchart of an example method for resource management;

FIG. 6 shows a flowchart of an example method for resource management; and

FIG. 7 shows an example block diagram of a computing device for resource management.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information”. Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG2, MPEG, MPEG4 UHD, HDR, 4 k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0,1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. Content items may be any combination of the above-described formats.

This detailed description may refer to a given entity performing some action. It should be understood that this language may in some cases mean that a system (e.g., a computer) owned and/or controlled by the given entity is actually performing the action.

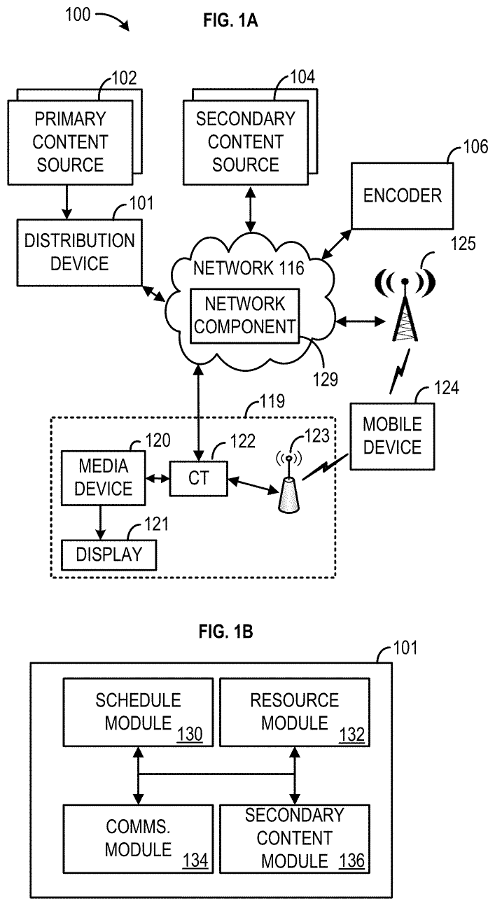

FIG. 1A shows an example system 100. Those skilled in the art will appreciate that digital equipment and/or analog equipment may be employed. Those skilled in the art will appreciate that provided herein is a functional description and that the respective functions may be performed by software, hardware, or a combination of software and hardware.

The system 100 may comprise a distribution device 101, a primary content source 102 (e.g., a content source of the variety of sources 102A, 102B, 102C), a secondary content source 104, an encoder 106, a network 116, a media device 120, and a mobile device 124. Each of the distribution device 101, primary content source 102, the secondary content source 104, and the encoder 106, and/or the media device 120 can be one or more computing devices, and some or all of the functions performed by these components may at times be performed by a single computing device.

The distribution device 101, the primary content source 102, the secondary content source 104, the encoder 106, and/or the media device 120 may be configured to communicate through the network 116. The network 116 may facilitate sending data, signals, content, combinations thereof and the like, to/from and between the primary content source 102, the distribution device 101, the secondary content source 104, the encoder 106, and/or any other device of FIG. 1A. For example, the network 116 may facilitate sending one or more primary content segments from the primary content source 102, and/or one or more secondary content segments from the secondary content source 104 to, for example, either or both of the media device 120 and/or the mobile device 124. The network 116 may be a content delivery network, a content access network, combinations thereof, and the like. The network may be managed (e.g., deployed, serviced) by a content provider, a service provider, combinations thereof, and the like. The network 116 may be an optical fiber network, a coaxial cable network, a hybrid fiber-coaxial network, a wireless network, a satellite system, a direct broadcast system, or any combination thereof. The network 116 can be the Internet. The network 116 may have a network component 129. The network component 129 may be any device, module, combinations thereof, and the like communicatively coupled to the network 116. The network component 129 may be a router, a switch, a splitter, a packager, a gateway, an encoder, a storage device, a multiplexer, a network access location (e.g., tap), physical link, combinations thereof, and the like.

The primary content source 102 may be configured to provide content (e.g., video, audio, games, applications, data) to a media device 120 associated with a premises 119. The primary content source 102 may be configured to provide linear television content. The primary content source 102 may be configured to provide streaming media, such as on-demand content (e.g., video on-demand), content recordings, and/or the like. The primary content source 102 may be managed by third party content providers, service providers, online content providers, over-the-top content providers, and/or the like. The content may be provided via a subscription, by individual item purchase or rental, and/or the like. The primary content source 102 may be configured to provide the content via a packet switched network path, such as via an internet protocol (IP) based connection.

The content may be accessed by applications, such as mobile applications, television applications, set-top box applications, gaming device applications, and/or the like. An application may be a custom application (e.g., by content provider, for a specific device), a general content browser (e.g., web browser), an electronic program guide, and/or the like. The primary content source 102 may be configured to send content (e.g., video, audio, movies, television, games, applications, data, etc.) to one or more devices such as the distribution device 101, the network component 129, a first access point 123, the mobile device 124, an edge device 125, and/or the media device 120. The primary content source 102 may be configured to send the content via a packet switched network path, such as via an IP based connection. The content may comprise a single content item, a portion of a content item (e.g., content fragment), a content stream, a multiplex that includes several content items, combinations thereof, and the like.

The primary content may comprise signaling data. The signaling data may comprise one or more markers. For example, the signaling data may comprise Society of Cable and Television Engineers 35 (SCTE-35) markers. The signaling data may be inserted into the content at the primary content source 102. The signaling data may be inserted by the primary content source 102 in a Moving Picture Experts Group (MPEG) bitstream, MPEG Supplemental Enhancement Information (SEI) messages, MPEG-2 Transport Stream (TS) packet, MPEG-2 Packetized Elementary Stream (PES) header data, ISO Base Media File Format (BMFF) data, ISO BMFF box, or any in any data packet. The Society of Cable Telecommunications Engineers 35 (SCTE35) is hereby incorporated by reference in its entirety. The Society of Cable Telecommunications Engineers 30 (SCTE30), the Society of Cable Telecommunications Engineers 130 (SCTE130), and the Society of Cable Telecommunications Engineers 244 (SCTE244) are also hereby incorporated by reference in their entirety.

The one or more markers may be associated with one or more content breaks. For example, the one or more markers may precede and/or trail the one or more content breaks. For example, the one or more markers comprise an indication. The indication may comprise a content break indication, a secondary content indication, a timing indication, or the like. For example, the content break indication may indicate a break in primary content. For example, the secondary content indication may indicate one or more inbound secondary content segments (e.g., a quantity of secondary content segments). For example, the timing indication may indicate a period of time associated with a content break of the one or more content breaks. For example, the timing indication may indicate a duration of the content break. For example, the distribution device 101 may parse one or more SCTE-35 messages carried within an MPEG transport stream of the content. For example, the distribution device 101 may determine an XML namespace prefix identifying the marker as an SCTE-35 marker. For example, the distribution device 101 may identify a cue_identifier_descriptor and/or a cue_stream_type value associated with the marker such as “splice_insert,” or “splice_schedule,” combinations thereof, and the like. The timing information may be located in, for example, a splice schedule. The splice schedule may indicate the duration of the content break.

The content distribution device 101 may receive a marker of the one or more markers and determine the duration of the content break. The broadcast event may comprise the one or more primary content segments. The primary content source 102 may send, to the distribution device 101, the one or more primary content segments. The one or more primary content segments may comprise a final primary content segment. For example, the final primary content segment may be associated with the end of the broadcast of the sporting event. The primary content source 102 may send, after the final content segment, a marker of the one or more markers. The marker may comprise the indication.

The distribution device 101 may determine, based on the indication, that the duration of the content break satisfies a timing threshold. For example, the distribution device 101 may compare the indication to a timing threshold. For example, the timing threshold may comprise a period of time (e.g., a number of seconds, minutes, hours, days, etc.) between the end of the broadcast of the sporting event a scheduled beginning of a broadcast of a second sporting event.

The signaling data may not indicate the duration of the content break. For example, the marker may not comprise the indication. The signaling data may simply indicate an end of the broadcast event. For example, the signaling data may comprise a sign-off indication. The sign-off indication may indicate the end of the broadcast (e.g., that the content source has gone offline, or is otherwise no longer broadcasting). For example, the signaling data may indicate a sign-off. The sign-off may be a final content segment or other data packet indicating the termination of a broadcast. The distribution device 101 may receive the sign off and determine the end of the broadcast. Based on determining the end of the broadcast, the distribution device may query the broadcast schedule to determine when a subsequent broadcast will begin.

The distribution device 101 or the encoder 106 may be configured to determine, even in the absence of the signaling data, the occurrence of a content break and the duration of the content break. For example, the distribution device 101 or the encoder 106 may determine, based on receiving, per one or more requests from one or more media devices, the one or more secondary content segments from the secondary content source. For example, the distribution device 101 or the encoder 106 may determine that it has received a quantity of identical secondary content segments in a row (e.g., back-to-back). The secondary content segments may be the same (e.g., the same frame). The distribution device 101 or the encoder 106 may determine the one or more secondary content segments are the same or similar (e.g., the one or more secondary content segments may comprise one or more slate content segments as described further herein). The distribution device 101 or the encoder 106 may determine the one or more secondary content segments are the same or similar based on a secondary content segment identifier associated with the one or more secondary content segments. Additionally and/or alternatively, the distribution device 101 or the encoder 106 may determine the one or more secondary content segments are the same or similar by performing video data analysis (e.g., video recognition) to determine payload content of the one or more secondary content segments is the same or similar.

The quantity of identical secondary content segments may satisfy a secondary content segment quantity threshold. For example, the identical secondary content segment quantity threshold may be 99 secondary content segments. The secondary content segment quantity threshold may be any value (e.g., any number or quantity of secondary content segments. For example, the distribution device 101 or the encoder 106 may determine that it has received 100 identical secondary content segments in a row. The distribution device may determine that the 100 identical secondary content segments satisfies the 99 secondary content segment threshold. The distribution device 101 or the encoder 106 may determine, based on the quantity of secondary content segments, a duration of the content break. For example, each secondary content segment of the one or more content segments may be associated with a playback duration (e.g., a uniform duration, an average duration, an aggregate duration, etc.) and the distribution device 101 or the encoder 106 may multiply the duration of the one or more secondary content segments by the quantity of content segments to determine the duration of the content break.

The duration of the content break may be associated with a schedule. For example, the primary content may comprise a broadcast event such as a regular broadcast event broadcast on a designated channel. For example, the designated channel may be designated for (e.g., regularly used for) broadcast content associated with a content source or subject. For example, the designated channel may be designated as an alert channel reserved to broadcast public emergency alerts such as news broadcasts and alerts, weather warnings, amber alerts, public addresses, combinations thereof, and the like. For example, the channel may be configured to send messages related to service outages, maintenance, weather information, or other purposes such as regional blackouts. For example the designated channel may be associated with The Weather Channel as the content source and may be configured for to broadcast regular (e.g., hourly, daily, weekly, etc.) weather reports. For example, the designated channel may be associated with a government body, government agency, police department, public health organization, combinations thereof, or the like and may be configured for regular broadcasts of legislative sessions, budget reporting, safety reporting, or any other regular or semi-regular broadcasts. The content source may regularly (e.g., routinely, periodically, with a frequency) broadcast the content. The content source may be associated with a broadcast schedule. The broadcast schedule may indicate when designated channel will be used to send broadcasts.

For example, the designated channel may be designated to broadcast one or more sporting events. For example, the designated channel may be associated with broadcasts of sporting events associated with a particular sports team, like the Saint Louis Cardinals baseball games. For example, the designated channel may be used for purposes of communicating network messages to network users.

For example, the primary content source may query a primary content schedule to determine the period of time between the end of the broadcast of the sporting event and the beginning of the broadcast of the second sporting event. For example, the primary content source 102 may comprise and/or query the broadcast schedule database. Similarly, the distribution device 101 may comprise and/or query the broadcast schedule database. The broadcast schedule database may comprise a sporting event schedule indicating when one or more sporting events are scheduled to occur and/or be broadcast. While the aforementioned example makes use of sporting events, a person skilled in the art will appreciate that the present systems and methods are suitable for any type of content.

The computing device may determine the indication in either or both of the broadcast schedule and/or the signaling data and compare the indication to the timing threshold. For example, the broadcast schedule may indicate that a broadcast of first content may begin on Sep. 24, 2021 at 4:30 PM and end on Sep. 24, 2021 at 5:30 PM. The broadcast schedule may further indicate a broadcast of second content begins at 10:00 PM on the same day, and thus, there is an intervening timespan of 4.5 hours between the broadcast of the first content and the second content. The distribution device 101 may compare the intervening timespan between broadcasts to the threshold. For example, the threshold may be 3 hours. The distribution device 101 may determine that the threshold of 3 hours is satisfied by the 4.5 hour intervening timespan.

Based on determining that the indication satisfies the timing threshold, the distribution device may send, to the encoder one or more instructions. For example, the encoder may be configured to execute one or more encoding operations. The one or more encoding operations may comprise, for example, processing primary content and/or secondary content. For example, the one or more encoding operations may comprise one or more formatting operations, one or more data compression operations, one or more data decompression operations, one or more data deflation operations, combinations thereof, and the like. For example, a first instruction of the one or more instructions may be configured to cause to encoder 106 to stop compressing data.

Based on determining that the indication satisfies the timing threshold, the distribution device 101 may send, for example, to the encoder 106, at least one secondary content segment of the one or more secondary content segments. For example, the secondary content source 104 may be configured to send, to the distribution device 101, and/or to any other device of the system 100, secondary content. The secondary content may comprise one or more secondary content segments. For example, the secondary content may comprise one or more slates, one or more advertisements, or any other content, combinations thereof, and the like. The one or more slates may comprise one or more frames of video, one or more segments of video, one or more clips, one or more still images, combinations thereof, and the like. For example, the one or more slates may comprise a short (e.g., usually less than 30 seconds) segment of content. For example, the one or more slates may comprise one or more frames of video. Each frame of the one or more frames may be different or the same. For example, the slate may be configured such that, when played on repeat (e.g., “looped”) the looping content may or may not have a discernable beginning or end. The slate may be configured to indicate a lack of broadcast programming.

For example, a second instruction of the one or more instructions may be configured to cause the encoder 106 to send, based on receiving the request for primary content, the secondary content. For example, the encoder 106 may receive, from the media device 120, a request for primary content. The second instruction may be configured to cause the encoder 106 to send, to, for example, the media device 120, the secondary content rather than the primary content. For example, a user associated with the premises 119 may attempt (e.g., request) to tune to a channel associated with (e.g., configured to output) the sporting event. However, based on the request to tune to the channel associated with the sporting event, the encoder 120 may determine the primary content (e.g., the sporting event) is not currently available. The primary content may not be currently available for any number of reasons including but not limited to: a team not presently participating in a sporting event, a technical problem with the network, or any other reason.

Similarly, based on determining the one or more secondary content segments are being encoded, the encoder 106 may determine the occurrence of a break in content and store, a secondary content segment of the one or more secondary content segments.

The network 116 may distribute signals from the distribution device 101 to user locations, such as a premises 119. The premises 119 may be associated with one or more viewers. For example, the premises 119 may be a viewer's home. A user account may be associated with the premises 119. The signals may be one or more streams of content. The streams of content may be audio content and/or video content. The audio content may comprise a stream separate from the video content. The network 116 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof.

A multitude of users may be connected to the network 116 at one or more of the user locations. At the premises 119, a media device 120 may demodulate and/or decode (e.g., determine one or more audio frames and video frames), if needed, the signals for display on a display device 121, such as on a television set (TV) or a computer monitor. The media device 120 may be a demodulator, decoder, frequency tuner, and/or the like. The media device 120 may be directly connected to the network (e.g., for communications via in-band and/or out-of-band signals of a content delivery network) and/or connected to the network 116 via a communication terminal 122 (e.g., for communications via a packet switched network). The media device 120 may be a set-top box, a digital streaming device, a gaming device, a media storage device, a digital recording device, a combination thereof, and/or the like. The media device 120 may comprise one or more applications, such as content viewers, social media applications, news applications, gaming applications, content stores, electronic program guides, and/or the like. Those skilled in the art will appreciate that the signal may be demodulated and/or decoded in a variety of equipment, including the communication terminal 122, a computer, a TV, a monitor, or a satellite dish.

The media device 120 may receive the content. The media device 120 may cause output of the content. The content may be output to enable one or more viewers (e.g., the viewers of the premises 119) to watch the content. The content may be displayed via the display device 121. The media device 120 may cause output of an advertisement associated with a content item. The media device 120 may determine whether the content item was output after the advertisement was displayed. The media device 120 may send a notification indicating the output content.

The communication terminal 122 may be located at the premises 119. The communication terminal 122 may be configured to communicate with the network 116. The communication terminal 122 may be a modem (e.g., cable modem), a router, a gateway, a switch, a network terminal (e.g., optical network unit), and/or the like. The communication terminal 122 may be configured for communication with the network 116 via a variety of protocols, such as internet protocol, transmission control protocol, file transfer protocol, session initiation protocol, voice over internet protocol, and/or the like. For a cable network, the communication terminal 122 may be configured to provide network access via a variety of communication protocols and standards, such as Data Over Cable Service Interface Specification (DOCSIS).

The premises 119 may comprise a first access point 123, such as a wireless access point. The first access point 123 may be configured to provide one or more wireless networks in at least a portion of the premises 119. The first access point 123 may be configured to provide access to the network 116 to devices configured with a compatible wireless radio, such as a mobile device 124, the media device 120, the display device 121, or other computing devices (e.g., laptops, sensor devices, security devices). The first access point 123 may provide a user managed network (e.g., local area network), a service provider managed network (e.g., public network for users of the service provider), and/or the like. It should be noted that in some configurations, some or all of the first access point 123, the communication terminal 122, the media device 120, and the display device 121 may be implemented as a single device.

The premises 119 may not be fixed. A user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, and/or the like. The mobile device 124 may communicate with a variety of access points (e.g., at different times and locations or simultaneously if within range of multiple access points). The mobile device 124 may communicate with a second access point 125. The second access point 125 may be a cell tower, a wireless hotspot, another mobile device, and/or other remote access point. The second access point 125 may be within range of the premises 119 or remote from premises 119. The second access point 125 may be located along a travel route, within a business or residence, or other useful locations (e.g., travel stop, city center, park).

Data may be inserted into the content at the primary content source 102. The data may be metadata. The primary content source 102 may encode data into the content. The metadata may be inserted by the device in a Moving Picture Experts Group (MPEG) bitstream, MPEG Supplemental Enhancement Information (SEI) messages, MPEG-2 Transport Stream (TS) packet, MPEG-2 Packetized Elementary Stream (PES) header data, ISO Base Media File Format (BMFF) data, ISO BMFF box, or any in any data packet. The metadata may be inserted at the input or output associated with a content source. The metadata may also be inserted at other stages in a content distribution network such as at a packager, at a cache device associated with the content distribution network, at an input to the client device, or by any device at any point along the content distribution. While the content source has been described as providing the audio content and video content, as well as encoding the metadata, for ease of explanation, a person of ordinary skill in the art would appreciate that any device in the system 100 may provide the content as well as encode the metadata such as, the edge device 125, described further below.

The system 100 may comprise an edge device 125. The edge device 125 may be configured to provide content, services, and/or the like to the premises 119. The edge device 125 may be one of a plurality of edge devices distributed across the network 116. The edge device 125 may be located in a region proximate to the premises 119. A request for content from the user may be directed to the edge device 125 (e.g., due to the location of the edge device and/or network conditions). The edge device 125 may be configured to package content for delivery to the user (e.g., in a specific format requested by a user device), provide the user a manifest file (e.g., or other index file describing portions of the content), provide streaming content (e.g., unicast, multicast), provide a file transfer, and/or the like. The edge device 125 may cache or otherwise store content (e.g., frequently requested content) to enable faster delivery of content to users.

As shown in FIG. 1B, the distribution device 101 may comprise a schedule module 130, a resource module 132, a communications module 134, and a secondary content module 136. While FIG. 1B describes the aforementioned modules, it is to be understood that the methods described herein may be performed by any one or more of the devices described herein. One or more broadcast schedules may be determined (e.g., by the schedule module 130, or any other module and/or computing device). The one or more broadcast schedules may be associated with primary content. For example, a broadcast schedule of the one or more schedules may indicate, for example, a scheduled broadcast date and time associated with content such as a broadcast event. For example, the broadcast schedule may indicate a start time for a first broadcast event on the channel, an end time for the first broadcast event, a start time for a second broadcast event on the channel, an end time for the second broadcast event, and so on. For example, the broadcast schedule may comprise an Electronic Program Guide (EPG) or similar schedules.

A resource requirement and/or resource requirement threshold may be determined (e.g., by the resource module 132, or any other module and/or computing device). The resource requirement may be associated with a task. The resource requirement may be associated with the indication. For example, the task may be a task related to distributing content such as an encoding task, a database query task, a manifest generation task, sending or receiving data, or other computing tasks related to content distribution. The resource requirement may indicate computing resources required to carry out the task. For example, the distribution device may determine a bandwidth requirement associated with sending, to a user device or media device, a quantity of content segments. For example, the distribution device 101 may determine, a time remaining in the intervening timespan. Similarly, the task may be an encoding task such as compressing or decompressing data. The distribution device 101 may determine, for example based on the quantity of content segments and the time remaining in the intervening timespan, a computing resource requirement associated with compressing or decompressing number of content segments, a required compression ratio, a computing requirement

For example, it may be determined that a media device may be configured to, during the duration of the break in the primary content, send one or more requests for one or more secondary content segments, receive, based on the one or more requests for the one or more secondary content segments, and processing the one or more secondary content segments requires an amount of bandwidth. For example, the distribution device 101 may determine, based on the end of the first content, a time remaining until the second content is broadcast, for example 4.5 hours. The distribution device 101 may determine, based on the time remaining, determine a quantity of content segments. The quantity of content segments may be determined by dividing the time remaining and an average content segment duration of one or more content segments (e.g., the slate, the secondary content, combinations thereof, and the like). For example, if the average content segment duration is 10 seconds (e.g., the slate content is 10 seconds in duration), the distribution device may determine the quantity of content segments is 1,620 segments (e.g., (4.5 hrs×60 mins×60 secs)/(10 sec/segment). The distribution device may determine a bandwidth requirement associated with sending the quantity of content segments. For example, distribution device 101 may determine a size of a content segment, an average size of the quantity of content segments, or the like, and determine the bandwidth requirement associated with sending the quantity of content segments (e.g., 1,620 mb at 1 mb per second). The distribution device may compare the resource requirement to a threshold and determine whether or not the resource requirement satisfies the threshold. For example, the 1,620 MB bandwidth requirement may satisfy a 1,000 MB bandwidth threshold. For example, the distribution device may determine a bandwidth requirement associated with sending, to a user device or media device, a quantity of content segments. For example, the distribution device 101 may determine, a time remaining in the intervening timespan. Similarly, the task may be an encoding task such as compressing or decompressing data. The distribution device 101 may determine, for example based on the quantity of content segments and the time remaining in the intervening timespan, a computing resource requirement associated with compressing or decompressing number of content segments, a required compression ratio, a computing requirement

The resource requirement may satisfy a resource requirement threshold. A person skilled in the art will appreciate that the resource requirement threshold may be associated with resource requirement for any computing task. For example, the resource requirement may comprise a bandwidth associated with a media device sending one or more requests for the one or more secondary content segments and sending, to the media device, from, for example, the distribution device or another device, the requested one or more secondary content segments. For example, it may be determined that, based on the duration of the content break, the media device would need to send 100 requests for content and in return, receive 100 one-minute content segments. It may be determined that the aforementioned request and receipt process may be required, over the duration of the break in the content 1,000 megabytes. The resource requirement threshold may be only 500 megabytes and thus, the resource requirement threshold would be satisfied in the aforementioned scenario.

The communications module 134 may be configured to communicate via one or more wireless networks. The communications module 134 may be configured to communicate via a specific network protocol.

The secondary content module 136 may be configured to send, receive, store, and/or process secondary content. The secondary content may comprise one or more secondary content segments. For example, the secondary content may comprise one or more slates, one or more advertisements, or any other content.

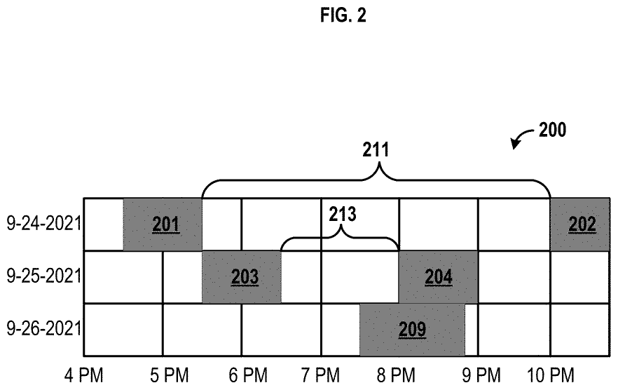

FIG. 2 shows an example broadcast schedule 200. The broadcast schedule 200 may be associated with a channel (e.g., the primary content source, the designated channel). For example, the broadcast schedule may be associated with a channel configured to delivery linear content programming. For example, the broadcast schedule may be associated with The Weather Channel, a channel designated for broadcast of events such as sporting events, music events, or any other content that may be broadcast regularly, semi-regularly, combinations thereof, and the like. For example, in the case that the primary content comprises broadcasts of The Weather Channel, the broadcast schedule may indicate regularly scheduled broadcasts occurring, for example, on an hourly bases, daily basis, or any other time frame or frequency. For example, the broadcast schedule 200 may indicate that a broadcast of first content 201 may begin on Sep. 24, 2021 at 4:30 PM and end on Sep. 24, 2021 at 5:30 PM. The broadcast schedule 200 may further indicate a broadcast of second content 202 begins at 10:00 PM on the same day, and thus, there is an intervening timespan 209 of 4.5 hours between the broadcast of the first content 201 and the second content 202. The distribution device 101 may compare the intervening timespan 209 between broadcasts to the threshold. For example, the threshold may be 3 hours. The distribution device 101 may determine that the threshold of 3 hours is satisfied by the 4.5 hour intervening timespan.

Based on determining the intervening timespan satisfies the threshold, the distribution device 101 may send one or more instructions for a downstream device. For example, the distribution device 101 may send the one or more instructions to the encoder 106. For example, the one or more instructions may cause the encoder 106 to execute one or more encoding operations. The one or more encoding operations may comprise, for example, processing primary content and/or secondary content. For example, the one or more encoding operations may comprise one or more formatting operations, one or more data compression operations, one or more data decompression operations, one or more data deflation operations, combinations thereof, and the like. For example, a first instruction of the one or more instructions may be configured to cause to encoder to stop compressing data.

For example, the broadcast schedule 200 may indicate that a broadcast of third content 203 may begin on Sep. 25, 2021 at 5:30 PM and end on Sep. 25, 2021 at 6:30 PM. The broadcast schedule 200 may further indicate a broadcast of fourth content 204 begins at 8:00 PM on the same day, and thus, there is an intervening timespan 213 of 1.5 hours between the broadcast of the third content 203 and the fourth content 204. The distribution device 101 may compare the intervening timespan 213 between broadcasts to the threshold. For example, the threshold may be 3 hours. The distribution device 101 may determine that the threshold of 3 hours is not satisfied by the 1.5 hour intervening timespan and thus may not send the one or more instructions to the encoder 106.

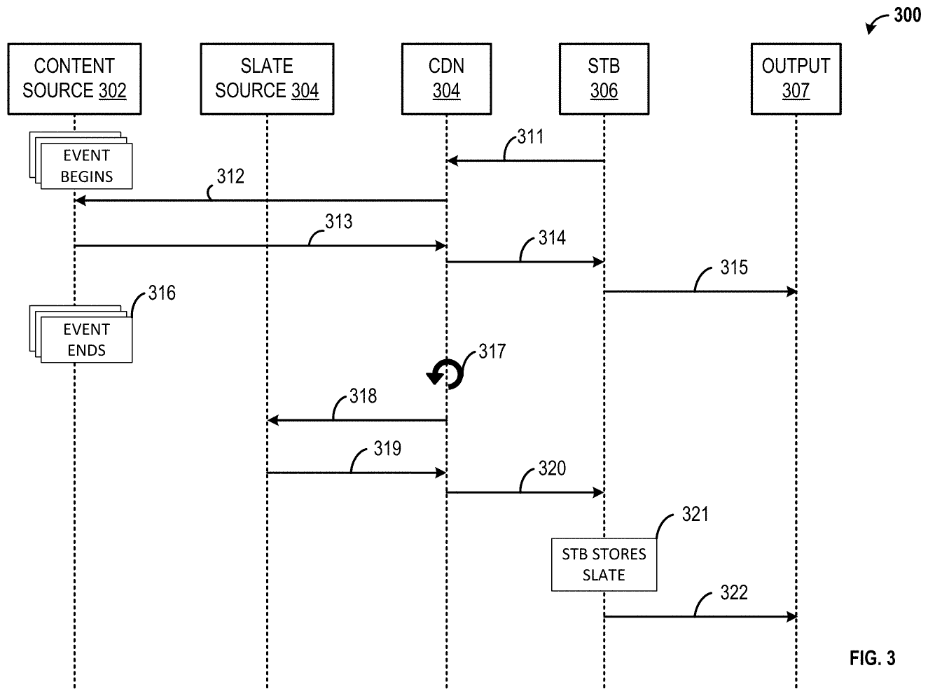

FIG. 3 shows an example flowchart of a method 300 as carried out via the system described herein. At step 311, a set-top-box (STB) 306 (e.g., the media device 120) may request content from a content distribution network 304 (e.g., the distribution device 101). For example, the STB 306 may request to tune to a channel (e.g., a designated channel) such as The Weather Channel, a designated sports channel, or any other channel. At step 312, the CDN 304 may, based on the request from the STB 306, send a request to content source 302 (e.g., the primary content source 102), for the requested content (e.g., a weather broadcast, sports broadcast, or the like). At step 313, the content source 302 may send the requested content to the CDN 304 to distribute to requesting devices such as the STB 306. At step 314, the CDN 304 may distribute the requested content (e.g., may broadcast the content) to, for example, the STB 306. At 315, the STB may output the content. At step 316, the broadcast event may end. For example, the content source 302 may send a final content segment indicating the end of the broadcast event.

Based on the broadcast event ending, the CDN, at step 317 may determine, for example the indication and timing threshold and/or the resource requirement and resource requirement threshold as described herein. Based on, for example, the timing indication and/or the resource requirement satisfying a threshold, the CDN 317 may request secondary content (e.g., a slate) from a secondary content source such as the slate source 304. The CDN 317 may determine a resource requirement associated with the indication as described herein. For example, the resource requirement may be associated with a task such as requesting, receiving, and sending content segments. For example, the CDN 317 may determine a bandwidth requirement associated with sending a quantity of content segments. For example, the CDN 317 may determine a size of a content segment, an average size of the quantity of content segments, or the like, and determine the bandwidth requirement associated with sending the quantity of content segments (e.g., 1,620 mb at 1 mb per second) for the duration of the indication. Thus, by requesting, receiving, and sending a single piece of secondary content with instructions for the media device to loop the content, rather than continuously requesting, receiving, and sending secondary content, computing resources may be used more efficiently and the efficiency of the CDN 317 may be improved. Based on the request for secondary content, the slate source 304 may, at step 319, send a slate segment to the CDN 304 for distribution. At step 320, the CDN 304 may send the slate to the STB 306 with instructions to store the slate content. The STB 306 may store the slate content, for example, in a cache. The instructions may instruct the STB 306 to maintain the slate content in the cache for the duration of the intervening timespan between broadcasts, and, upon a request to tune to the channel, output the slate via output 307 (e.g., at step 322).

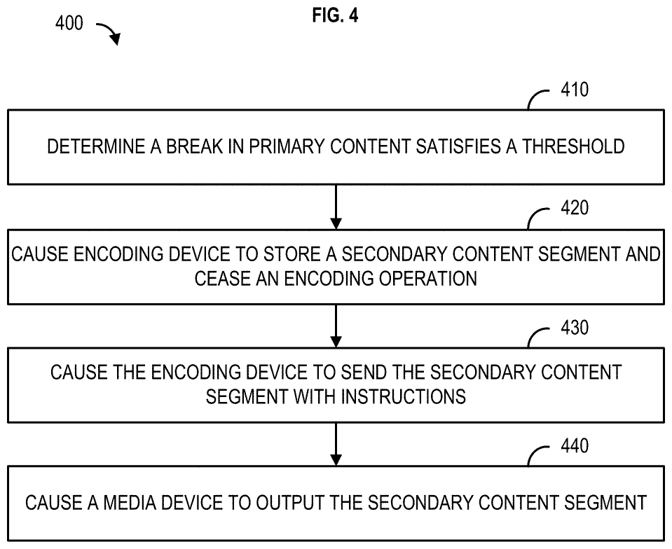

FIG. 4 shows a flowchart of a method 400 for resource management. For example, the method 400 may be carried out any one or more of the distribution device 101, the primary content source 102, the secondary content source 104, and/or the encoder 106. At step 410, a break in primary content may be determined. For example, distribution device 101, the primary content source 102, the secondary content source 104, and/or the encoder 106 may determine, based on an indication in primary content, that the break in the primary content satisfies a timing threshold. The primary content may be associated with (e.g., originate from) a primary content source. The primary content source may comprise or otherwise be associated with a channel. The break in the primary content may be determined, for example, by a distribution device. For example, the distribution device may receive, from a primary content source primary content comprising one or more primary content segments. For example, the primary content source may be a broadcast source and the primary content may comprise a broadcast or any other transmission of the primary content. For example, a final content segment of the one or more content segments may be associated with a termination or ending of the broadcast. The primary content may comprise a marker. For example, the marker may be a SCTE-35 marker. The marker and/or a primary content segment of the one or more primary content segments may comprise the indication (e.g., the timing indication). For example, a field of the SCTE-35 marker may be populated with the indication. The indication may indicate a duration of a break in primary content. The indication may comprise an indication of a length of time between an end of the broadcast of the primary content and a beginning of a broadcast of subsequent primary content. For example, the primary content may comprise a sporting event and the subsequent primary content may comprise a subsequent sporting event (e.g., a next schedule sporting event). The distribution device or the encoder may be configured to determine, even in the absence of the signaling data, the occurrence of a content break and the duration of the content break. For example, the distribution device or the encoder may determine, based on receiving, per one or more requests from one or more media devices, the one or more secondary content segments from the secondary content source. Similarly, based on determining the one or more secondary content segments are being encoded, the encoder may determine the occurrence of a break in content and store, a secondary content segment of the one or more secondary content segments.

The duration of the break in the primary content may be associated with, for example, a broadcast schedule. In the case that the primary content comprises the broadcast of the sporting event, the broadcast schedule may indicate a schedule of sporting events (e.g., such as a calendar). For example, the schedule may indicate that a broadcast of a first sporting event on the channel may end on Sep. 24, 2021 at 1:30 PM, a broadcast of a second sporting event on the channel may begin on Sep. 25, 2021 at 2:30 PM and end on Sep. 25, 2021 at 4:30 PM, and a broadcast of a third sporting event on the channel may begin on Sep. 25, 2021 at 4:30 PM.

The duration of the break in the primary content may satisfy the timing threshold. For example, the timing threshold may comprise a number of seconds, minutes, hours, days, etc. between broadcasts. For example, the timing threshold may be 24 hours. A person skilled in the art will appreciate that a threshold of any duration (e.g., length) may be used. For example, the duration of the break in content may be 25 hours and thus, the duration of the break in the content (e.g., as indicated by the timing indication) satisfies the timing threshold.

At step 420, based on the break in the primary content satisfying the timing threshold, an encoding device may be caused to store a secondary content segment and to cease an encoding operation. For example, the distribution device may send a message to the encoding device. For example, the distribution device may send a message to an encoding device. The message may comprise a data packet or the like. The message may comprise secondary content. The secondary content may comprise one or more secondary content segments. For example, the secondary content may comprise one or more slates, one or more advertisements, or any other content. The message may comprise one or more instructions. For example, the message may comprise first instructions of the one or more instructions. For example, the first instructions may be configured to cause the encoding device to begin, cease, or otherwise take one or more encoding operations. For example, the one or more encoding operations may comprise one or more formatting operations, one or more data compression operations, one or more data decompression operations, one or more data deflation operations, combinations thereof, and the like. For example, a first instruction of the one or more instructions may be configured to cause to encoding device to stop compressing data.

For example, the first instructions may be configured to cause the encoding device to store one or more content segments. For example, the first instructions may be configured to cause the encoding device to store one or more advertisements, one or more slates, one or more primary content segments, one or more secondary content segments, combinations thereof, and the like.

At step 430, the encoding device may be caused to send the secondary content (e.g., the one or more secondary content segments) to a media device (e.g., a client device, a user device, etc.). For example, the distribution device 101 may send a message to the encoding device, wherein the message is configured to cause the encoding device to send the secondary content. For example, the media device may comprise an STB, a smart phone, a computer, or the like. For example, the distribution device may cause the encoding device to send the secondary content. The encoding device may be caused to send the secondary content based on a request. For example, the encoding device may receive a request for primary content. The request for primary content may comprise, for example, a request to tune to the channel. Similarly, the distribution device may receive the request, the primary content source may receive the request, a secondary content source may receive the request. A person skilled in the art will appreciate that any device described herein may receive the request for content and communicate that request, via a network, to any other device in the system. The encoding device may send the secondary content to the media device with second instructions. The second instructions may be configured to cause the media device to execute one or more media operations. For example, the one or more media operations may comprise storing, sending, outputting, or otherwise processing data (e.g., content, requests for content, and the like). For example, the second instructions may be configured to cause the media device to store at least one secondary content segment of the one or more secondary content segments. For example, the second instructions may be configured to cause the media device to store the at least one secondary content segment in temporary storage such as a cache, or the like.

At step 440, the media device may be caused to output the secondary content. For example, the media device may be configured to automatically output the secondary content and/or the distribution device 101 or the encoder 106 may send a message to the media device, wherein the message is configured to cause the media device to output the secondary content. For example, the second instructions may be configured to cause the media device to output the at least one content segment. For example, the second instructions may be configured to cause the media device to loop at least one secondary content segment rather than sending repeated requests for the one or more secondary content segments during the duration of the break in the primary content. A person skilled in the art will appreciate that looping content comprises causing content to be outputted repeatedly (e.g., more than once).

For example, the at least one secondary content segment may comprise a segment of content of a certain length (e.g., a still frame, a one second video and/or audio clip, 40 seconds, one minute, etc.). The media device may be caused to repeatedly output (e.g., display) the at least one secondary content segment for a period of time associated with (e.g., based on, a portion of, approximately equal to) the duration of the content break. For example, if the content break is 24 hours long, and the secondary content segment is a one minute video clip, the media device may be caused to output the at least one secondary content segment for the remainder of the content break (e.g., the time between when the request for the content is received and the end of the content break), or until the media device is caused to tune away from the channel. Causing the media device to repeatedly output the stored secondary content, rather than repeatedly send requests and receive, based on the repeated requests, the one or more secondary content segments may reduce network traffic and thereby increases available network bandwidth. Further, causing the media device to repeatedly output the stored secondary content, rather than repeatedly send requests and receive, based on the repeated requests, may reduce other resource demands such as encoding demands and thereby increase available encoding resources and/or other network resources.

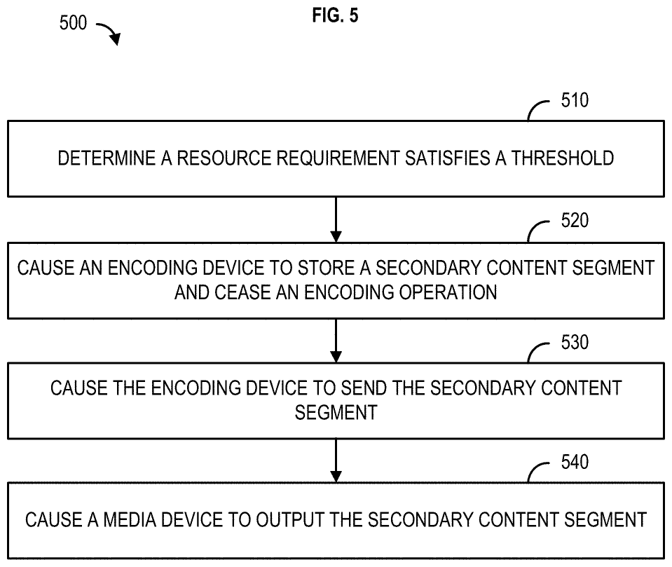

FIG. 5 shows a flowchart of a method 500 for resource management. At step 510, a resource requirement may be determined to satisfy a threshold. For example, any one or more of the distribution device 101, the primary content source 102, the secondary content source 104, and/or the encoder 106 may determine the resource requirement satisfies the resource requirement threshold. The distribution device or encoder may determine the resource requirement satisfies the resource requirement threshold based on an indication in a content stream. The resource requirement may be associated with one or more encoding operations, and/or one or more media operations. The one or more encoding operations and/or the one or more media operations may be associated with primary content and/or secondary content. For example, the one or more encoding operations may comprise one or more formatting operations, one or more data compression operations, one or more data decompression operations, one or more data deflation operations, combinations thereof, and the like. For example, the one or more media operations may comprise storing, sending, outputting, or otherwise processing data (e.g., content, requests for content, and the like).

The primary content may be associated with (e.g., originate from) a primary content source. The primary content source may comprise or otherwise be associated with a channel. The resource requirement may be associated with a break in the primary content. The break in the primary content may be determined, for example, by the distribution device. For example, the distribution device may receive, from a primary content source primary content comprising one or more primary content segments. For example, the primary content source may be a broadcast source and the primary content may comprise a broadcast or any other transmission of the primary content. For example, a final content segment of the one or more content segments may be associated with a termination or ending of the broadcast. The primary content may comprise a marker. For example, the marker may be a SCTE-35 marker. The marker and/or a primary content segment of the one or more primary content segments may comprise the indication. For example, a field of the SCTE-35 marker may be populated with the indication. The indication may indicate a duration of a break in primary content. The indication may comprise an indication of a length of time between an end of the broadcast of the primary content and a beginning of a broadcast of subsequent primary content. For example, the primary content may comprise a sporting event and the subsequent primary content may comprise a subsequent sporting event (e.g., a next schedule sporting event). The distribution device or the encoder may be configured to determine, even in the absence of the signaling data, the occurrence of a content break and the duration of the content break. For example, the distribution device or the encoder may determine, based on receiving, per one or more requests from one or more media devices, the one or more secondary content segments from the secondary content source. Similarly, based on determining the one or more secondary content segments are being encoded, the encoder may determine the occurrence of a break in content and store, a secondary content segment of the one or more secondary content segments.

The duration of the break in the primary content may be associated with, for example, a broadcast schedule. In the case that the primary content comprises the broadcast of the sporting event, the broadcast schedule may indicate a schedule of sporting events (e.g., such as a calendar). For example, the schedule may indicate that a broadcast of a first sporting event on the channel may begin on Sep. 24, 2021 at 4:30 PM and end on Sep. 24, 2021 at 5:30 PM, a broadcast of a second sporting event on the channel may begin on Sep. 25, 2021 at 5:30 PM and end on Sep. 25, 2021 at 6:30 PM, and a broadcast of a third sporting event on the channel may begin on Sep. 25, 2021 at 8:30 PM.

The resource requirement may be determined by determining a resource requirement associated with a task (e.g., an encoding operation of the one or more encoding operations and/or a media operation of the one or more media operations). For example, it may be determined that a media device may be configured to, during the duration of the break in the primary content, send one or more requests for one or more secondary content segments, receive, based on the one or more requests for the one or more secondary content segments, and process the one or more secondary content segments requires an amount of bandwidth.

The resource requirement may satisfy a resource requirement threshold. A person skilled in the art will appreciate that the resource requirement threshold may be associated with resource requirement for any computing task. For example, the resource requirement may comprise a bandwidth associated with a media device sending one or more requests for the one or more secondary content segments and sending, to the media device, from, for example, the distribution device or another device, the requested one or more secondary content segments. For example, it may be determined that, based on the duration of the content break, the media device would need to send 100 requests for content and in return, receive 100 one-minute content segments. It may be determined that the aforementioned request and receipt process may be required, over the duration of the break in the content 1,000 megabytes. The resource requirement threshold may be only 500 megabytes and thus, the resource requirement threshold would be satisfied in the aforementioned scenario.

At step 520, based on the resource requirement threshold being satisfied, the distribution device bay cause the encoder to store the one or more secondary content segments and cease one or more encoding operations. For example, the distribution device may send a message to the encoder. For example, the distribution device 101 may send a message to an encoding device. The message may comprise a data packet or the like. The message may comprise secondary content. The secondary content may comprise one or more secondary content segments. For example, the secondary content may comprise one or more slates, one or more advertisements, or any other content. The message may comprise one or more instructions. For example, the message may comprise first instructions of the one or more instructions. For example, the first instructions may be configured to cause the encoding device to begin, cease, or otherwise take one or more encoding operations. For example, the one or more encoding operations may comprise one or more formatting operations, one or more data compression operations, one or more data decompression operations, one or more data deflation operations, combinations thereof, and the like. For example, a first instruction of the one or more instructions may be configured to cause to encoding device to stop compressing data.

For example, the first instructions may be configured to cause the encoding device to store one or more content segments. For example, the first instructions may be configured to cause the encoding device to store one or more advertisements, one or more slates, one or more primary content segments, one or more secondary content segments, combinations thereof, and the like.

At step 530, the encoding device may be caused to send the secondary content (e.g., the one or more secondary content segments) to a media device (e.g., a client device, a user device, etc.). For example, the distribution device 101 may send a message to the encoder 106 wherein the message is configured to cause the encoder to send to the secondary content. For example, the media device may comprise an STB, a smart phone, a computer, or the like. For example, the distribution device may cause the encoding device to send the secondary content. The encoding device may be caused to send the secondary content based on a request for the primary content. For example, the encoding device may receive a request for primary content. The request for primary content may comprise, for example, a request to tune to the channel. Similarly, the distribution device may receive the request, the primary content source may receive the request, a secondary content source may receive the request. A person skilled in the art will appreciate that any device described herein may receive the request for content and communicate that request, via a network, to any other device in the system. The encoding device may send the secondary content to the media device with second instructions. The second instructions may be configured to cause the media device to execute one or more media operations. For example, the one or more media operations may comprise storing, sending, outputting, or otherwise processing data (e.g., content, requests for content, and the like). For example, the second instructions may be configured to cause the media device to store at least one secondary content segment of the one or more secondary content segments. For example, the second instructions may be configured to cause the media device to store the at least one secondary content segment in temporary storage such as a cache, or the like.

At step 540, the media device may be caused to output the secondary content. For example, the media device may be configured to automatically output the secondary content and/or the distribution device 101 or the encoder 106 may send a message to the media device, wherein the message is configured to cause the media device to output the secondary content. For example, the second instructions may be configured to cause the media device to output the at least one content segment. For example, the second instructions may be configured to cause the media device to loop to at least one secondary content segment. A person skilled in the art will appreciate that looping content comprises causing content to be outputted repeatedly (e.g., more than once).

For example, the at least one secondary content segment may comprise a segment of content of a certain length (e.g., a still frame, a one second video and/or audio clip, 30 seconds, one minute, etc.). The media device may be caused to repeatedly output (e.g., display) the at least one secondary content segment for a period of time associated with (e.g., based on, a portion of, approximately equal to) the duration of the content break. For example, if the content break is 24 hours long, and the secondary content segment is a one minute video clip, the media device may be caused to output the at least one secondary content segment for the remainder of the content break (e.g., the time between when the request for the content is received and the end of the content break), or until the media device is caused to tune away from the channel rather than sending repeated requests for the one or more secondary content segments during the duration of the break in the primary content. Causing the media device to repeatedly output the stored secondary content, rather than repeatedly send requests and receive, based on the repeated requests, the one or more secondary content segments may reduce network traffic and thereby increases available network bandwidth. Further, causing the media device to repeatedly output the stored secondary content, rather than repeatedly send requests and receive, based on the repeated requests, may reduce other resource demands such as encoding demands and thereby increase available encoding resources and/or other network resources.

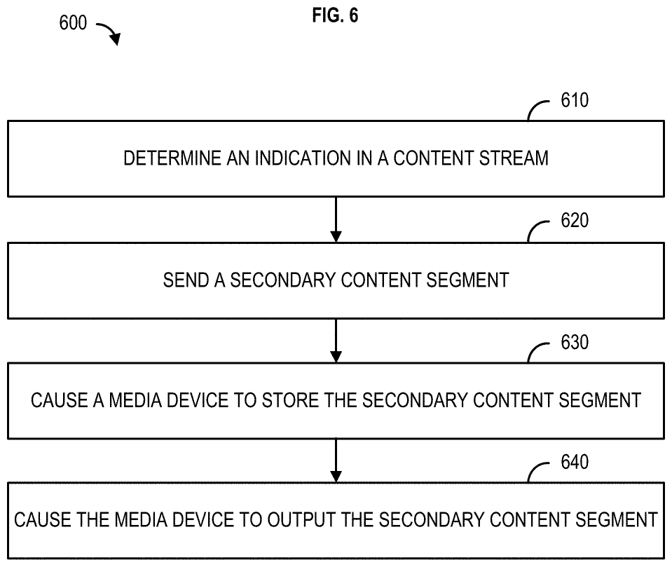

FIG. 6 shows a flowchart of a method 600 for resource management. For example, the method 600 may be carried out by any one or more of the distribution device 101, the primary content source 102, the secondary content source 104, and/or the encoder 106. At step 610, an indication in a content stream associated with primary content (e.g., a channel) may be determined. For example the distribution device 101 may determine the indication. For example, the indication may be sent from a primary content source to the distribution device. The indication may be a timing indication. For example, the primary content source may send, to the distribution device, primary content comprising signaling data. The signaling data may comprise one or more markers. For example, the signaling data may comprise Society of Cable and Television Engineers 35 (SCTE-35) markers. The Society of Cable Telecommunications Engineers 35 (SCTE-35) is hereby incorporated by reference in its entirety. The Society of Cable Telecommunications Engineers 30 (SCTE-30), the Society of Cable Telecommunications Engineers 244 (SCTE-244), and the Society of Cable Telecommunications Engineers 130 (SCTE-130) are also hereby incorporated by reference in their entirety. The one or more markers may be associated with one or more content breaks. For example, the one or more markers may precede and/or trail the one or more content breaks. The distribution device or the encoder may be configured to determine, even in the absence of the signaling data, the occurrence of a content break and the duration of the content break. For example, the distribution device or the encoder may determine, based on receiving, per one or more requests from one or more media devices, the one or more secondary content segments from the secondary content source. Similarly, based on determining the one or more secondary content segments are being encoded, the encoder may determine the occurrence of a break in content and store, a secondary content segment of the one or more secondary content segments.

For example, the one or more markers comprise the indication. The indication may indicate a period of time associated with a content break of the one or more content breaks. For example, the indication may indicate a duration of the content break. For example, the content distribution device may receive a marker of the one or more markers the indication and determine, based on the indication, the duration of the content break. The duration of the content break may be associated with a schedule. For example, the primary content may comprise a broadcast event such as a sporting event. The sporting event may comprise the one or more primary content segments. The primary content source may send, to the distribution device, the one or more primary content segments. The one or more primary content segments may comprise a final primary content segment. For example, the final primary content segment may be associated with the end of the broadcast of the sporting event. The primary content source may send, after the final content segment, a marker of the one or more markers.

At step 620, at least one content segment may be sent. The at least one content segment may be at least one secondary content segment (e.g., a segment of slate content). The at least one content segment may be sent, for example, by the distribution device 101 or an encoding device 106, to at least one media device of a plurality of media devices. The at least one content segment may comprise at least one secondary content segment. The at least one content segment may be based on the timing information satisfying a timing threshold. For example, the timing threshold may comprise a number of seconds, minutes, hours, days, etc. between broadcasts. For example, the timing threshold may be 24 hours. A person skilled in the art will appreciate that a threshold of any duration (e.g., length) may be used. For example, the duration of the break in content may be 25 hours and thus, the duration of the break in the content (e.g., as indicated by the timing indication) satisfies the timing threshold.

The at least one content segment may be sent to the at least one media device based on a request. The request may comprise a request for content. For example, the request may comprise a request to tune to a channel. For example, a media device (e.g., an STB) may request tune to the channel.

At step 630, each media device of the plurality of media devices may be caused to store the at least one content segment. For example, the distribution device 101 or the encoder 106 may send a message to each media device. The message may comprise a data packet or the like. The message may comprise secondary content. The secondary content may comprise one or more secondary content segments. For example, the secondary content may comprise one or more slates, one or more advertisements, or any other content. The message may comprise one or more instructions. For example, the message may comprise first instructions of the one or more instructions. For example, the first instructions may be configured to each media device to store the at least one content segment. For example, the first instructions may be configured to cause each media device to store one or more advertisements, one or more slates, one or more primary content segments, one or more secondary content segments, combinations thereof, and the like.

At step 640, each media device may be caused to output the secondary content. For example, the media device may be configured to automatically output the secondary content and/or the distribution device 101 or the encoder 106 may send a message to the media device, wherein the message is configured to cause the media device to output the secondary content. For example, the second instructions may be configured to cause the media device to output the at least one content segment. For example, the second instructions may be configured to cause the media device to loop to at least one secondary content segment. A person skilled in the art will appreciate that looping content comprises causing content to be outputted repeatedly (e.g., more than once).

For example, the at least one secondary content segment may comprise a segment of content of a certain length (e.g., a still frame, a one second video and/or audio clip, 30 seconds, one minute, etc.). The media device may be caused to repeatedly output (e.g., display) the at least one secondary content segment for a period of time associated with (e.g., based on, a portion of, approximately equal to) the duration of the content break. For example, if the content break is 24 hours long, and the secondary content segment is a one minute video clip, the media device may be caused to output the at least one secondary content segment for the remainder of the content break (e.g., the time between when the request for the content is received and the end of the content break), or until the media device is caused to tune away from the channel rather than sending repeated requests for the one or more secondary content segments during the duration of the break in the primary content. Causing the media device to repeatedly output the stored secondary content, rather than repeatedly send requests and receive, based on the repeated requests, the one or more secondary content segments may reduce network traffic and thereby increases available network bandwidth. Further, causing the media device to repeatedly output the stored secondary content, rather than repeatedly send requests and receive, based on the repeated requests, may reduce other resource demands such as encoding demands and thereby increase available encoding resources and/or other network resources.

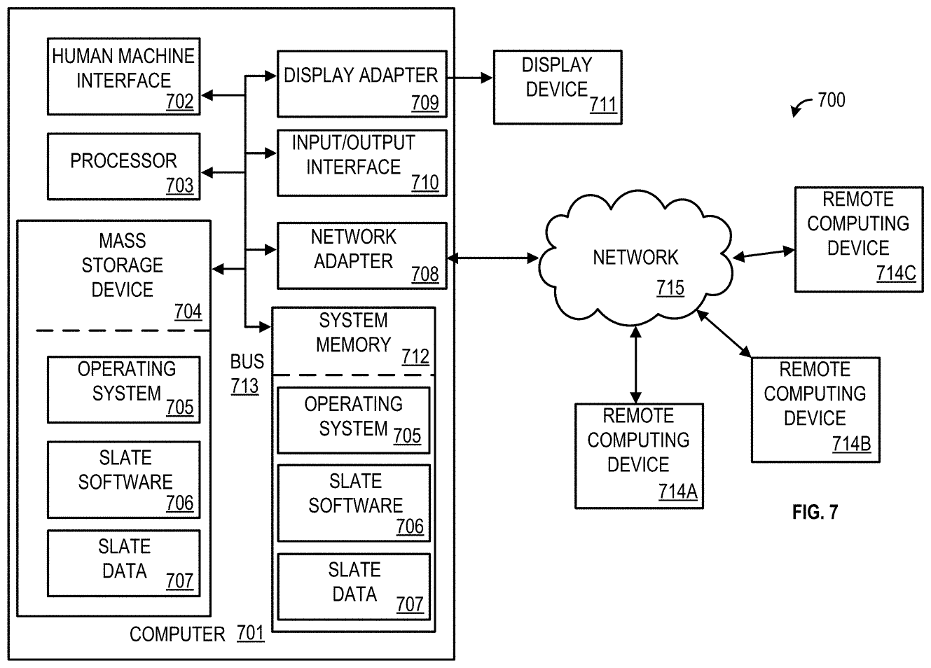

FIG. 7 shows a system 700 for resource management. The computer 701 may comprise one or more processors 703, a system memory 712, and a bus 713 that couples various system components including the one or more processors 703 to the system memory 712. In the case of multiple processors 703, the computer 701 may utilize parallel computing. The bus 713 is one or more of several possible types of bus structures, including a memory bus or memory controller, a peripheral bus, an accelerated graphics port, or local bus using any of a variety of bus architectures.

The computer 701 may operate on and/or comprise a variety of computer readable media (e.g., non-transitory). The readable media may be any available media that is accessible by the computer 701 and may comprise both volatile and non-volatile media, removable and non-removable media. The system memory 712 has computer readable media in the form of volatile memory, such as random access memory (RAM), and/or non-volatile memory, such as read only memory (ROM). The system memory 712 may store data such as the slate data 707 and/or program modules such as the operating system 705 and the slate software 706 that are accessible to and/or are operated on by the one or more processors 703. The machine learning module may comprise one or more of the slate data 707 and/or the slate software 706.

The computer 701 may also comprise other removable/non-removable, volatile/non-volatile computer storage media. FIG. 7 shows the mass storage device 704 which may provide non-volatile storage of computer code, computer readable instructions, data structures, program modules, and other data for the computer 701. The mass storage device 704 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 704, such as the operating system 705 and the predicting software 706. Each of the operating system 705 and the slate software 706 (or some combination thereof) may comprise elements of the program modules and the slate software 706. The slate data 707 may also be stored on the mass storage device 704. The slate data 707 may be stored in any of one or more databases known in the art. Such databases may be DB2®, Microsoft® Access, Microsoft® SQL Server, Oracle®, MySQL, PostgreSQL, and the like. The databases may be centralized or distributed across locations within the network 715.

A user may enter commands and information into the computer 701 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 703 via a human machine interface 702 that is coupled to the bus 713, but may be connected by other interface and bus structures, such as a parallel port, game port, an IEEE 1394 Port (also known as a Firewire port), a serial port, network adapter 708, and/or a universal serial bus (USB).

The display device 711 may also be connected to the bus 713 via an interface, such as the display adapter 709. It is contemplated that the computer 701 may comprise more than one display adapter 709 and the computer 701 may comprise more than one display device 711. The display device 711 may be a monitor, an LCD (Liquid Crystal Display), light emitting diode (LED) display, television, smart lens, smart glass, and/or a projector. In addition to the display device 711, other output peripheral devices may be components such as speakers (not shown) and a printer (not shown) which may be connected to the computer 701 via the Input/Output Interface 710. Any step and/or result of the methods may be output (or caused to be output) in any form to an output device. Such output may be any form of visual representation, including, but not limited to, textual, graphical, animation, audio, tactile, and the like. The display device 711 and computer 701 may be part of one device, or separate devices.

The computer 701 may operate in a networked environment using logical connections to one or more remote computing devices 714A,B,C. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 701 and a remote computing device 714A,B,C may be made via a network 715, such as a local area network (LAN) and/or a general wide area network (WAN). Such network connections may be through the network adapter 708. The network adapter 708 may be implemented in both wired and wireless environments. Such networking environments are conventional and commonplace in dwellings, offices, enterprise-wide computer networks, intranets, and the Internet.

Application programs and other executable program components such as the operating system 705 are shown herein as discrete blocks, although it is recognized that such programs and components reside at various times in different storage components of the computing device 701, and are executed by the one or more processors 703 of the computer. An implementation of the slate software 706 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
determining, by a content distribution device, based on an indication in a content stream, that a break in primary content satisfies a timing threshold;
based on the break in the primary content satisfying the timing threshold, causing an encoding device to store a secondary content segment and to cease an encoding operation;
based on receiving a request for the primary content, causing the encoding device to send the secondary content segment to a media device with instructions; and
causing, based on the instructions, the media device to output the secondary content segment.

2. The method of claim 1, wherein the indication in the content stream comprises one or more of: a timing indication, a SCTE-35 marker, or a SCTE-224 marker.

3. The method of claim 1, wherein the timing threshold comprises a period of time between one or more scheduled broadcasts.

4. The method of claim 1, wherein the request for primary content is received from the media device, and wherein the content distribution device comprises a head end, wherein the encoding device comprises an encoder/transcoder, and wherein the media device comprises at least one of: a set top box, a smart phone, or a computer.

5. The method of claim 1, wherein the encoding operation comprises generating one or more content segments adhering to at least one of: to H.264/MPEG-AVC, H.265/MPEG-HEVC, H.266/MPEG-VVC, MPEG-5 EVC, MPEG-5 LCEVC, AV1, MPEG2, MPEG, MPEG4 UHD, SDR, HDR, 4 k, Adobe® Flash® Video (.FLV), ITU-T H.261, ITU-T H.262 (MPEG-2 video), ITU-T H.263, ITU-T H.264 (MPEG-4 AVC), ITU-T H.265 (MPEG HEVC), or ITU-T H.266 (MPEG VVC).

6. The method of claim 1, wherein the instructions are further configured to cause the media device to store the secondary content segment for a predetermined time and wherein the predetermined time is associated with a broadcast schedule.

7. The method of claim 1, wherein the secondary content segment comprises slate content comprising one or more of: one or more frames of video, one or more segments of video, one or more clips, or one or more still images.

8. The method of claim 1, wherein causing the media device to output the secondary content segment comprises causing the media device to store the secondary content segment; and
repeatedly output the stored secondary content.

9. A method comprising:
determining, by a content distribution device, based on an indication in a content stream, that a resource requirement associated with primary content that satisfies a resource requirement threshold;
based on the resource requirement satisfying the resource requirement threshold, causing an encoding device, to store a secondary content segment and cease an encoding operation;
causing the encoding device to send, based on receiving a request for the primary content, the secondary content segment to a media device with instructions; and
causing, based on the instructions and the request, the media device to output the secondary content segment.

10. The method of claim 9, wherein the resource requirement is associated with at least one of: an encoding capacity, a processing power, a bandwidth availability, a network traffic parameter, a quality of service requirement, or a resolution requirement.

11. The method of claim 9, wherein the content distribution device comprises a head end, wherein the encoding device comprises an encoder/transcoder, and wherein the media device comprises at least one of: a set top box, a smart phone, or a computer.

12. The method of claim 9, wherein causing the media device to output the secondary content segment comprises causing the media device to store and repeatedly output the secondary content segment.

13. The method of claim 9, wherein the instructions are further configured to cause the media device to store the secondary content segment.

14. The method of claim 13, further comprising:
receiving, by the content distribution device, a request for different primary content; and
causing, based on the request, the media device to cease output of the secondary content segment.

15-20. (canceled)

21. An apparatus, comprising:
one or more processors; and
a memory storing processor executable instructions that, when executed by the one or more processors, cause the apparatus to:
determine, based on an indication in a content stream, that a break in primary content satisfies a timing threshold;
based on the break in the primary content satisfying the timing threshold, cause an encoding device to store a secondary content segment and to cease an encoding operation;
based on receiving a request for the primary content, cause the encoding device to send the secondary content segment to a media device with instructions; and
cause, based on the instructions, the media device to output the secondary content segment.

22. The apparatus of claim 21, wherein the indication in the content stream comprises one or more of: a timing indication, a SCTE-35 marker, or a SCTE-224 marker.

23. The apparatus of claim 21, wherein the timing threshold comprises a period of time between one or more scheduled broadcasts.

24. The apparatus of claim 21, wherein the request for primary content is received from the media device, and wherein the content distribution device comprises a head end, wherein the encoding device comprises an encoder/transcoder, and wherein the media device comprises at least one of: a set top box, a smart phone, or a computer.

25. The apparatus of claim 21, wherein the encoding operation comprises generating one or more content segments adhering to at least one of: to H.264/MPEG-AVC, H.265/MPEG-HEVC, H.266/MPEG-VVC, MPEG-5 EVC, MPEG-5 LCEVC, AV1, MPEG2, MPEG, MPEG4 UHD, SDR, HDR, 4 k, Adobe® Flash® Video (.FLV), ITU-T H.261, ITU-T H.262 (MPEG-2 video), ITU-T H.263, ITU-T H.264 (MPEG-4 AVC), ITU-T H.265 (MPEG HEVC), or ITU-T H.266 (MPEG VVC).

26. The apparatus of claim 21, wherein the instructions are further configured to cause the media device to store the secondary content segment for a predetermined time and wherein the predetermined time is associated with a broadcast schedule.

27. The apparatus of claim 21, wherein the secondary content segment comprises slate content comprising one or more of: one or more frames of video, one or more segments of video, one or more clips, or one or more still images.

28. The apparatus of claim 21, wherein the processor executable instructions that, when executed by the one or more processors, cause the apparatus to cause the media device to output the secondary content segment, further cause the media device to:
store the secondary content segment; and
repeatedly output the stored secondary content segment.

29. An apparatus, comprising:
one or more processors; and
a memory storing processor executable instructions that, when executed by the one or more processors, cause the apparatus to:
determine, by a content distribution device, based on an indication in a content stream, that a resource requirement associated with primary content that satisfies a resource requirement threshold;
based on the resource requirement satisfying the resource requirement threshold, cause an encoding device, to store a secondary content segment and cease an encoding operation;
cause the encoding device to send, based on receiving a request for the primary content, the secondary content segment to a media device with instructions; and
cause, based on the instructions and the request, the media device to output the secondary content segment.

30. The apparatus of claim 29, wherein the resource requirement is associated with at least one of: an encoding capacity, a processing power, a bandwidth availability, a network traffic parameter, a quality of service requirement, or a resolution requirement.

31. The apparatus of claim 29, wherein the content distribution device comprises a head end, wherein the encoding device comprises an encoder/transcoder, and wherein the media device comprises at least one of: a set top box, a smart phone, or a computer.

32. The apparatus of claim 29, wherein the processor executable instructions that, when executed by the one or more processors, cause the apparatus to cause the media device to output the secondary content segment, further cause the media device to store and repeatedly output the secondary content segment.

33. The apparatus of claim 29, wherein the instructions are further configured to cause the media device to store the secondary content segment.

34. The apparatus of claim 29, wherein the processor executable instructions, when executed by the one or more processors, further cause the apparatus to:
receive, by the content distribution device, a request for different primary content; and
cause, based on the request, the media device to cease output of the secondary content segment.
